(19) United States
(12) Patent Application Publication
(10) Pub. No.: US 2008/0313363 A1
(43) Pub. Date: Dec. 18, 2008

(54) Method and Device for Exchanging Data Using a Virtual Fifo Data Structure

(75) Inventors: Yoram Granit, Kfar-Saba (IL); Adi Katz, Ramat Gan (IL); Gil Lidji, Zur Yiga'al (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 12/279,952

(22) PCT Filed: Feb. 20, 2006
(86) PCT No.: PCT/IB06/50539

§ 371 Date: Aug. 19, 2008

(51) Int. Cl. G06F 13/28

(52) U.S. Cl. 710/24

(57) ABSTRACT

A method and a device for exchanging data. The method includes: requesting the processor, by the data transfer controller, to initiate a transfer of multiple data chunks from the second memory unit to the Virtual FIFO data structure, in response to a status of the virtual FIFO data structure; sending the data transfer controller, by the processor a request acknowledgment and an indication about a size of a group of data chunks to be transferred to the virtual FIFO data structure; updating the state of the virtual FIFO data structure; transferring, by the second level DMA controller, the group of data chunks from the second memory unit to the virtual FIFO data structure; sending, by the processor a DMA completion acknowledgment indicating that the group of data chunks was written to the virtual FIFO data structure; and transferring, by a first level DMA controller, a data chunk from the virtual FIFO data structure to the hardware FIFO memory unit.

### FIELD OF THE INVENTION

The invention relates to a device and a method for exchanging data and especially for a device and method for exchanging data using a virtual FIFO data structure.

### BACKGROUND OF THE INVENTION

In today's telecommunications, digital networks transport large amounts of information. Network services can be, for example, traditional voice phone, facsimile, television, audio and video broadcast, and data transfer.

With the increasing need of information exchange in the global society, the capacity of existing and future networks must be used efficiently.

Communication integrated circuits use various techniques, such as time division multiplexing (TDM), to transmit information from multiple communication channels over a single communication line, as well as to receive information the is destined to many communication channels. Exemplary communication integrated circuits and TDM methods are illustrated in U.S. Pat. No. 6,771,630 of Weitz et al., and U.S. Pat. No. 6,167,059 of Hagai et al., both being incorporated herein by reference. An exemplary TDM scheme is illustrated in U.S. Pat. No. 4,855,996 of Douskalis.

In a typical communication integrated circuit many components are involved in the processing of data. Some of these components (such as but not limited to processors) also execute additional tasks. In addition, some components participate in the processing of data packets or data frames that arrive from many communication channels.

In order to bridge between the responses of the various components, and, sometimes, to compensate for latencies various memory units are used. These memory units usually include First In First Out (FIFO) memory units. U.S. Pat. No. 5,444,853 and U.S. patent application publication serial number 2005/0125571, which are incorporated herein by reference, describe two prior art FIFO units as well as virtual FIFO data structures that are used in communication integrated circuit. The first is adapted to operate with a slow communication protocol, while the other is both time and resource consuming. It requires a processor to monitor the state of various memory unit, thus is ineffective.

There is a need to provide efficient methods for exchanging data, especially efficient method and device that exchange data using a virtual FIFO data structure.

### SUMMARY OF THE PRESENT INVENTION

A device and method for exchanging data, as described in the accompanying claims.

### BRIEF DESCRIPTION OF THE DRAWINGS

The present invention will be understood and appreciated more fully from the following detailed description taken in conjunction with the drawings in which:

FIG. 1 illustrates a device according to an embodiment of the invention;

FIG. 2 illustrates a device according to an embodiment of the invention;

FIG. 3 illustrates various signals that are exchanged between various components of the device, according to an embodiment of the invention;

FIG. 4 illustrates various signals that are exchanged between various components of the device, according to an embodiment of the invention;

FIG. 5 illustrates a virtual FIFO data structure, according to an embodiment of the invention;

FIG. 6 illustrates a flow chart of a method, according to an embodiment of the invention;

FIG. 7 illustrates a flow chart of a method, according to an embodiment of the invention;

FIG. 8 illustrates various signals that are exchanged between various components of the device, according to an embodiment of the invention;

FIG. 9 illustrates various signals that are exchanged between various components of the device, according to an embodiment of the invention;

FIG. 10 illustrates a flow chart of a method, according to an embodiment of the invention; and

FIG. 11 illustrates a flow chart of a method, according to an embodiment of the invention.

### DETAILED DESCRIPTION OF THE DRAWINGS

The invention provides a device and a method for exchanging data using a virtual FIFO data structure. Conveniently, a data transfer controller monitors a relatively small hardware FIFO memory unit and a virtual FIFO data structure. This small hardware controller can efficiently initiate and control data transfers between the hardware FIFO memory unit and the virtual FIFO data structure.

Conveniently multiple virtual FIFO data structures are stored in one or more memory units, and they (the virtual FIFO data structures) can store data from multiple small hardware FIFO memory units.

Conveniently, one hardware FIFO memory unit can store data from one or more virtual FIFO data structures.

Conveniently, multiple data chunks that do not amount to a full data block can be grouped to form a group of data chunks. The device can process a group of data chunks from one data block, then another group of data chunks from another data block. Accordingly, the device and method can pipeline the processing and transfer of data chunks.

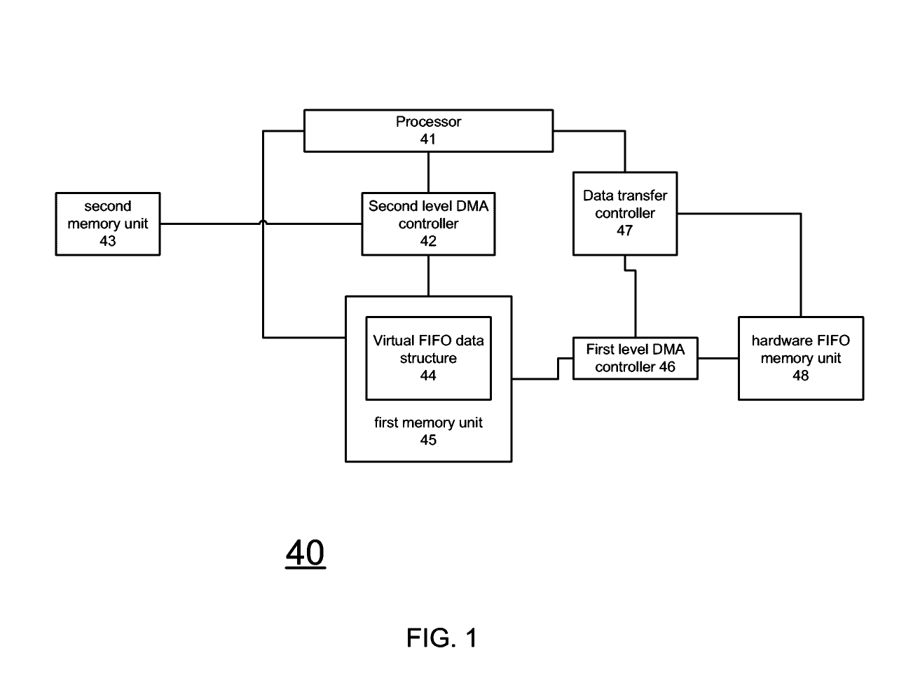

FIG. 1 illustrates device 40 according to an embodiment of the invention. Device 40 can include one or more integrated circuits, can be a mobile device, a cellular phone, a personal data accessory, a music player, a base station, a router, a switch, a computer, and the like.

Device 40 includes a processor 41, a hardware FIFO memory unit 48, a first level DMA controller 46, a second level DMA controller 42, a first memory unit 45 that stores at least one virtual FIFO data structure 44 and a data transfer controller 47.

The first level DMA controller 46 is connected to the hardware FIFO memory unit 48, to the first memory unit 45 and to the data transfer controller 47. The second level DMA controller 42 is connected to the first memory unit 45, to a second memory unit 43 and to the processor 41.

The data transfer controller 47 is connected to the processor 41, to the first level DMA controller 46 and to the HW FIFO memory unit 48. The data transfer controller 47 initiates transfer of data chunks between the hardware FIFO memory unit 48 and the virtual FIFO data structure 44 and initiates a transfer of data blocks between the second memory unit 43 and the virtual FIFO data structure 44.

The processor 41 is adapted to determine a size of a data block. A data block includes multiple data chunks. The size of the data chunks is determined in response to the size of the hardware FIFO memory unit 48. Conveniently, the hardware FIFO memory unit stores one data chunk at a time but can also store multiple data chunks at a time.

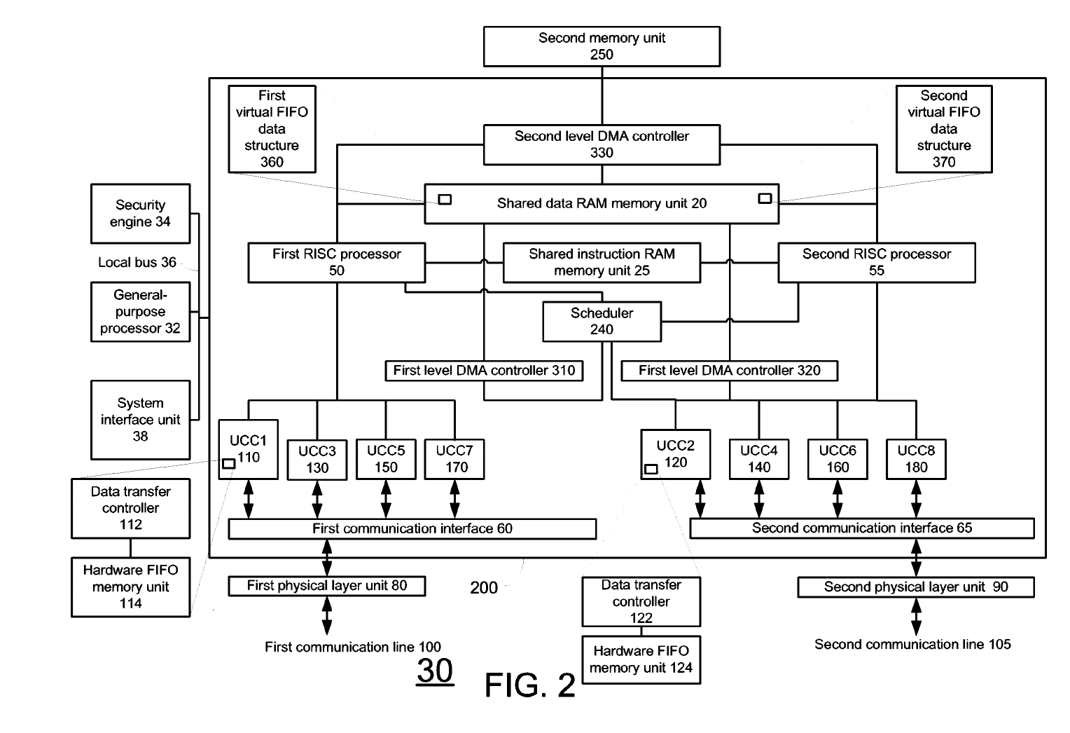

FIG. 2 illustrates a device 30, according to an embodiment of the invention.

Device 30 includes a general-purpose processor 32, a security engine 34, system interface unit 38, communication engine 200 and multiple ports (not shown). Components 32, 34, 38 and 200 are connected to each other by local bus 36.

The general-purpose processor 32 can include multiple execution units such as but not limited to an integer unit, a branch processing unit, a floating point unit, a load/store unit and a system register unit. It can also include various cache memories, dynamic power management unit, translation look aside buffers, and the like.

The general-purpose processor 32 controls the device 30 and can execute various programs according to the required functionality of device 30. The general-purpose processor 32 can be a member of the PowerPC™ family but this is not necessarily so.

The security engine 34 can apply various security mechanisms including encryption based mechanisms and the like.

Device 30 can be connected to multiple memory units as well as other components. These components are interfaced by system interface unit 38. System interface unit 38 may include some of the following components: external memory controllers, external DDR interface unit, PCI bridge, local bus, bus arbitrator, dual UART unit, dual I²C unit, a four channel DMA controller, an interrupt controller, and the like. It is noted that other interfacing components can be used.

Communication engine 200 is a versatile communication component that can manage multiple communication ports that operate according to different communication protocols.

According to an embodiment of the invention multiple hardware FIFO memory units share the same first memory unit. This first memory unit usually stores at least one virtual FIFO data structure per hardware FIFO memory unit.

Processor 41 is adapted to manage multiple tasks. It can be a general-purpose processor, a digital signal processor, a RISC processor and the like. Conveniently, the data transfers are designed such as to reduce the interaction with the processor 41. In addition, the transmission of data chunks is executed substantially without an involvement of processor 41.

Communication engine 200 includes multiple communication controllers of different types. Each communication controller can manage one or more communication channels. Conveniently, each communication channel is associated with a single virtual FIFO data structure. A bi-directional communication channel is viewed as a combination of a receive communication channel and a transmit communication channel. Each such communication channel can have its own data transfer controller, virtual FIFO data structure, hardware FIFO memory unit, and the like.

It is noted that one or more communication channels can be controlled by a single data transfer controller, but this is not necessarily so.

The communication engine 200 includes two RISC processors 50 and 55, second level DMA controller 330, a shared data memory unit 20, a shared instruction memory unit 25, scheduler 240, two first level DMA controllers 310 and 320, a second memory unit 250, eight universal communication controllers denoted UCC1-UCC8 110-180, as well as additional communication controllers (not shown It is noted that additional components, such as but not limited to various ports, time slots assigners and the like were omitted for simplicity of explanation.

The first RISC processor 50 is connected to UCC1 110, UCC3 130, UCC5 150, UCC7 170, scheduler 240, shared instruction memory unit 25 and shared data memory unit 20. The access to the first RISC controller can be managed by scheduler 240.

The second RISC processor 55 is connected to UCC2 120, UCC4 140, UCC6 160, UCC8 180, scheduler 240, shared instruction memory unit 25 and shared data memory unit 20. The access to the first RISC controller can be managed by scheduler 240.

The first level DMA controllers 310 and 320 are connected to the shared data memory unit 20 and to data transfer controllers within the various communication controllers.

Each communication controller out of communication controllers UCC1-UCC8 110-180 can include transmission paths as well as reception paths.

Conveniently, a UCC can support the following communication protocols and interfaces (not all simultaneously): 10/100 Mbps Ethernet, 1000 Mpbs Ethernet, IPv4 and IPv6, L2 Ethernet switching, ATM protocol via UTOPIA interface, various types of HDLC, UART, and BISYNC.

In addition, the communication engine 200 can include a controller (not shown) as well as an interrupt unit that coordinate the various components of the communication engine, as well as to enable the communication engine 200 to communicate with general-purpose processor 32, security engine 34 and system interface unit 38.

Conveniently, a group of communication controllers are connected to a single first level DMA controller, but this is not necessarily so. For example, first level DMA controller 310 serves communication controllers UCC1, UCC3, UCC5 and UCC7 110, 130, 150 and 170 respectively, while first level DMA controller 320 serves communication controllers UCC2, UCC4, UCC6, UCC8 and 120, 140, 160, 180 respectively.

According to an embodiment of the invention multiple communication controllers can use a single first memory unit that stores multiple virtual FIFO data structures. This single first memory unit can be connected to multiple first level DMA controllers. For example, communication controllers 110-120 use different virtual FIFO data structures (such as virtual FIFO data structures 360 and 370), that are stored in shared data memory unit 20.

Communication engine 200 can include multiple components that are analogues to the components of FIG. 1. For convenience of explanation two virtual FIFO data structures 360 and 370, two data transfer controllers 112 and 122 as well as two hardware FIFO memory units 114 and 124 are illustrated.

UCC1 110 has a reception path that includes data transfer controller 112 and hardware FIFO memory unit 114. UCC2 120 has a reception path that includes data transfer controller 122 and hardware FIFO memory unit 124. It is noted that other universal communication controllers can include such components, that the shared data memory unit 20 can store more than two virtual FIFO data structures 360 and 370. It is further noted that UCC1 110 and UCC2 120 can also include transmission paths that are not illustrated.

Conveniently, virtual FIFO data structure 360, data transfer controller 112, hardware FIFO memory unit 114, first level DMA controller 310, second level DMA controller 330, second memory unit 250 and first RISC processor 50 interact in a manner that is analogues to the interactions between virtual FIFO data structure 44, data transfer controller 47, hardware FIFO memory unit 48, first level DMA controller 46, second level DMA controller 42, second memory unit 43 and processor 41.

Conveniently, virtual FIFO data structure 370, data transfer controller 122, hardware FIFO memory unit 124, first level DMA controller 320, second level DMA controller 330, second memory unit 250 and second RISC processor 55 interact in a manner that is analogues to the interactions between virtual FIFO data structure 44, data transfer controller 47, hardware FIFO memory unit 48, first level DMA controller 46, second level DMA controller 42, second memory unit 43 and processor 41.

Conveniently, the reception process includes receiving data and optionally metadata by the hardware FIFO memory unit 114 (or 124), sending data chunks to virtual FIFO data structure 360 (or 370) and then sending data blocks to second memory unit 250. It is noted that the hardware FIFO memory unit 114 can also receive metadata from the data transfer controller 47.

The size of the data block is conveniently determined (for example—for each UCC and for each path out of a reception path and a transmission path of that UCC) by the first RISC processor 50 or the second RISC processor 55. The size is usually responsive to communication protocol limitations. It is usually 2^{X} bytes, whereas X is a positive integer. The block size is also responsive to the latency of the first (or second) RISC processor 50 (or 55).

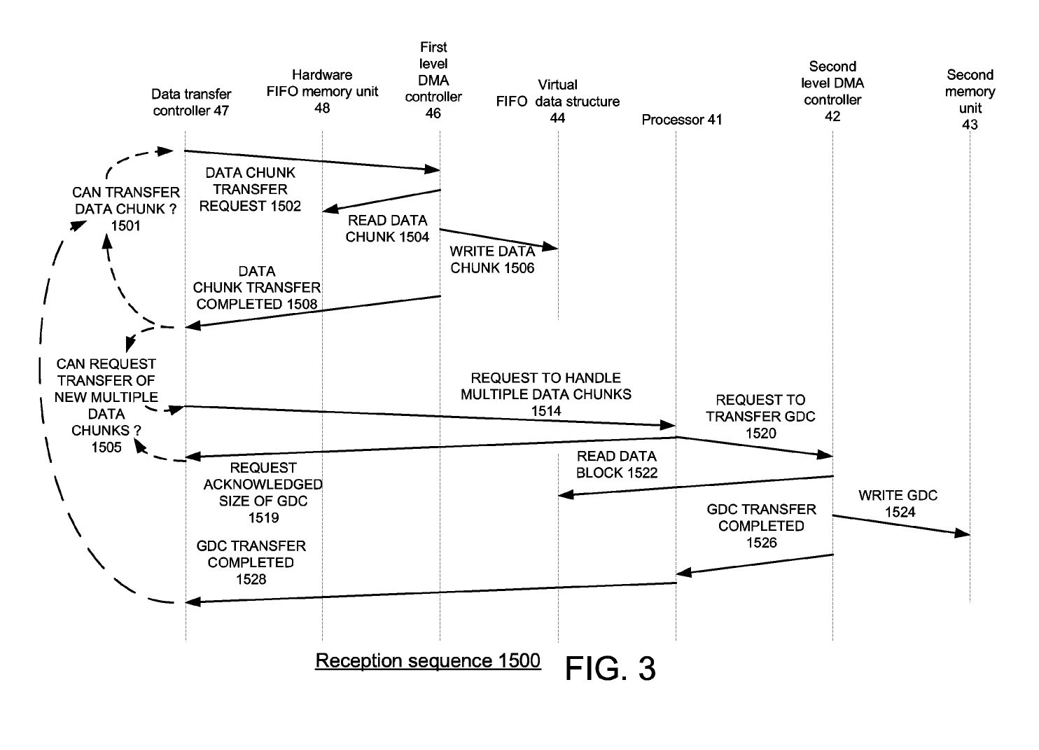

FIG. 3 illustrates various signals that are exchanged between various components of device 40, during reception sequence 1500, according to an embodiment of the invention. It is assumed that data is transferred from the hardware FIFO memory unit 48 to the second memory unit 43.

Various operations and signals are illustrated by arrows that extend between components that are involved in various stages of the reception process.

A data reception process starts by a sending a request (DATA CHUNK TRANSFER REQUEST 1502) to provide a data chunk from the hardware FIFO memory unit 48 to virtual FIFO data structure 44. The request is sent from data transfer controller 47 to first level DMA controller 46.

The first level DMA controller 46 accepts the request and reads a data chunk from the hardware FIFO memory unit 48 (READ DATA CHUNK 1504).

The first level DMA controller 46 then writes the data chunk to the virtual FIFO data structure 44 (WRITE DATA CHUNK 1506).

Once the data chunk transfer was completed the first level DMA controller 46 sends an indication (DATA CHUNK TRANSFER COMPLETED 1508) to data transfer controller 47.

The data transfer controller 47 then checks (CAN TRANSFER DATA CHUNK 1501?) if it can transfer a new data chunk from the hardware FIFO memory unit 48 to the virtual FIFO data structure, and if the virtual FIFO memory unit can receive another data chunk then the data transfer controller 47 sends a new data chunk transfer request.

In addition, the data transfer controller 47 asks whether it can request the processor 41 to transfer multiple data chunks from the virtual FIFO data structure, and optionally process these data chunks (CAN REQUEST TRANSFER OF NEW MULTIPLE DATA CHUNKS 1505?).

The data transfer controller 47 is aware of a maximal amount of data chunks that the processor 41 can handle. This maximal amount is limited to a data block.

Assuming that a request can be generated then the data transfer controller 47 sends such a request (REQUEST TO HANDLE MULTIPLE DATA CHUNKS 1514) to the processor 41.

The processor receives the request and determines the size of a group of data chunks (GDC) that will be managed by the processor and/or transferred by the second level DMA controller 42 to the second memory unit 43. The processor 41 can process the GDC, request the second level DMA controller 42 to transfer the GDC (REQUEST TO TRANSFER GDC 1520) and also send a first acknowledgment to the data transfer controller 47 indicating that the request was received and also informs the data transfer controller 47 the size of the GDC (REQUEST ACKNOWLEDGED, SIZE OF GDC 1519).

The data transfer controller 47 then determines whether it can send a new request to the processor 41 to handle multiple data chunks from the virtual FIFO data structure, and optionally process these data chunks. The determination is based upon the difference between the actual data chunks transfer to Virtual FIFO and the size of previous GDC that was is to be handled (as reported by the processor on previous GDC) It is noted that the data transfer controller does not wait till the data is actually transferred from the virtual FIFO data structure, thus the data transfer and optionally data processing can be pipelined.

The processor 41, after receiving the request (1514), also sends the second level DMA controller 42 a request to transfer the GDC from the virtual FIFO data structure to the second memory unit 43 (REQUEST TO TRANSFER GDC 1520).

The second level DMA controller 42 performs the transfer, by reading the GDC from the virtual FIFO data structure 44 (READ GDC 1522), writing the GDC to the second memory unit 43 (WRITE GDC 1524) and informs the processor 41 when the transfer is completed (GDC TRANSFER COMPLETED 1526).

The processor 41 sends the data transfer controller 47 a notification that the GDC transfer was completed GDC TRANSFER COMPLETED 1528).

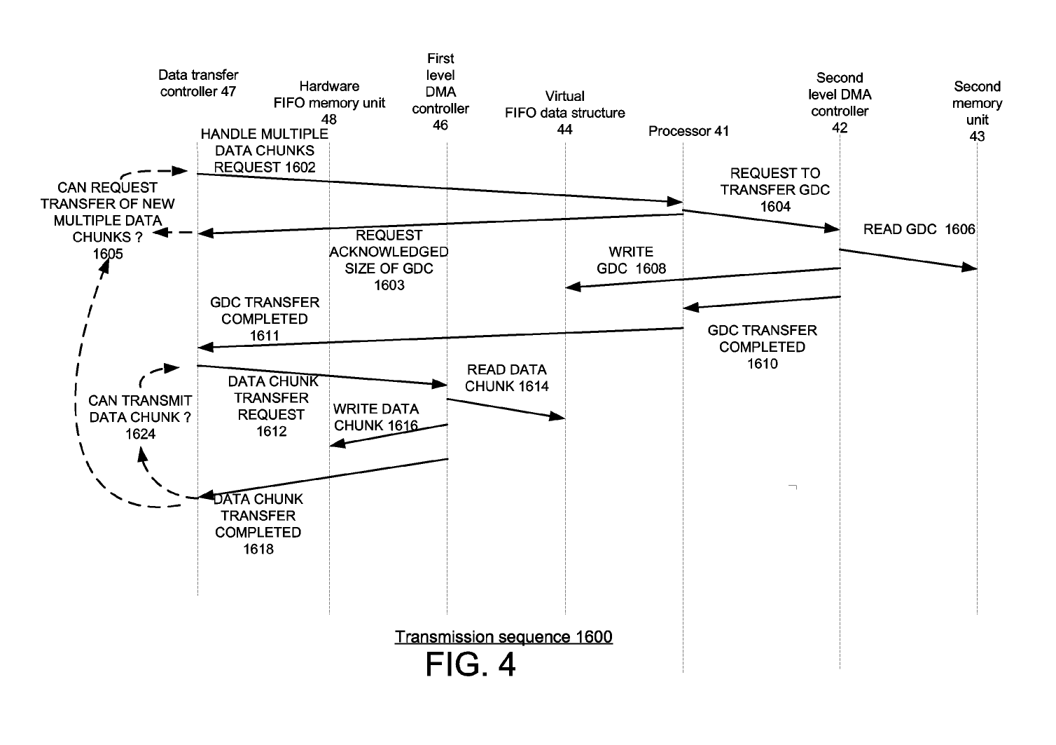

FIG. 4 illustrates various signals that are exchanged between various components of device 40, during transmission sequence 1600, according to another embodiment of the invention.

It is assumed that data is transferred to the hardware FIFO memory unit 48 from the second memory unit 43.

Various operations and signals are illustrated by arrows that extend between components that are involved in various stages of the transmission process.

A data transmission process starts by a sending a request (HANDLE MULTIPLE DATA CHUNKS REQUEST 1602), by the data transfer controller 47 to the processor 41 to transfer multiple data chunks from the second memory unit 43 to the virtual FIFO data structure 44.

The data transfer controller 47 is aware of the maximal size of data chunks that can be transferred by the processor 41 (data block), thus it sends such a request if the virtual FIFO data structure 44 can receive a data block.

The processor 41 receives the request, determines the size of the GDC it will manage and sends a reception acknowledgement and a size of GDC indication (REQUEST ACKNOWLEDGED, SIZE OF GDC 1603) to the data transfer controller 47 and also sends a request (REQUEST TO RECEIVE GDC 1604) to the second level DMA controller 42 to transfer the GCD from the second memory unit 43 to the virtual FIFO data structure 44.

The data transfer controller 47 asks whether it can request the processor 41 to transfer additional multiple data chunks to the virtual FIFO data structure, (CAN REQUEST TRANSFER OF NEW MULTIPLE DATA CHUNKS 1605?). The request is send in response to the estimated status of the vitrual FIFO data structure, assuming that a GDC is written to the virtual FIFO data structure 44. Such a request can be sent if the virtual FIFO data structure can receive a new data block, assuming that a GDC is written to it.

Assuming that a request can be generated then the data transfer controller 47 sends an additional request (HANDLE MULTIPLE DATA CHUNKS REQUEST 1602) to the processor 41.

In parallel, independently from the data transfer controller 47, the second level DMA controller 42 performs the transfer, by reading the GDC from the second memory unit 43 (READ GDC 1606), writing the GDC to the virtual FIFO data structure 44 (WRITE GDC 1608) and informs the processor 41 when the transfer is completed (GDC TRANSFER COMPLETED 1610).

The processor 41 sends the data transfer controller 47 a notification that the GDC transfer was completed (GDC TRANSFER COMPLETED 1611).

The data transfer controller 47 sends a request to the first level DMA controller 46 to transfer a data chunk from the virtual FIFO data structure 44 to the hardware FIFO memory unit 48 (DATA CHUNK TRANSFER REQUEST 1612). The first level DMA controller 46 accepts the request, reads a data chunk from the virtual FIFO data structure 44 (READ DATA CHUNK 1614) and writes it to the hardware FIFO memory unit 48 (WRITE DATA CHUNK 1616). The first level DMA controller 46 then sends an indication (DATA CHUNK TRANSFER COMPLETED 1618) to the data transfer controller 47.

The data transfer controller 47 then checks (CAN TRANSFER DATA CHUNK? 1624) if it can transfer a new data chunk to the hardware FIFO memory unit 48 from the virtual FIFO data structure, and if so it sends a new data chunk transfer request.

In addition, the data transfer controller 47 asks whether it can request the processor 41 to transfer multiple data chunks to the virtual FIFO data structure, and optionally process these data chunks (CAN REQUEST TRANSFER OF NEW MULTIPLE DATA CHUNKS 1605?).

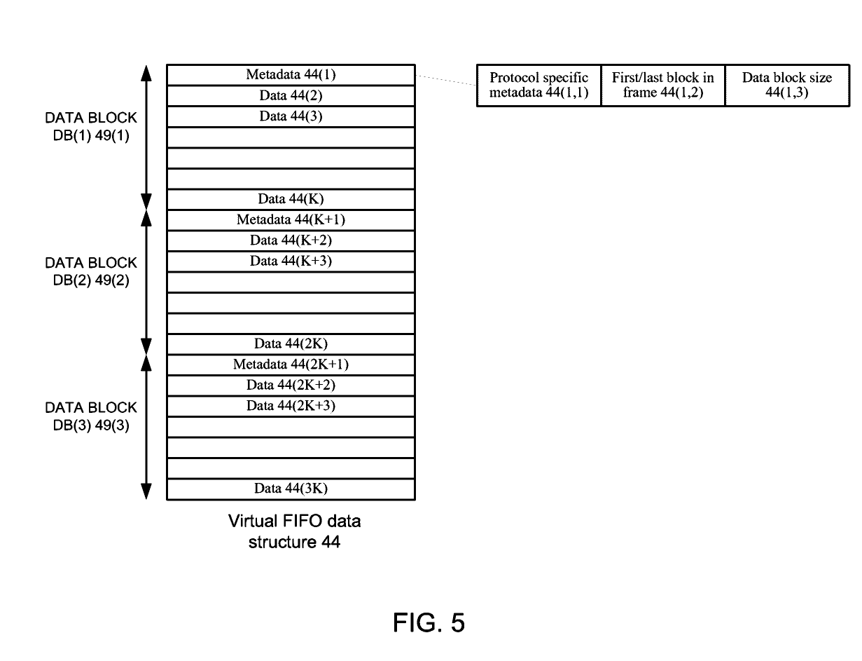

FIG. 5 illustrates a virtual FIFO data structure 44, according to an embodiment of the invention.

The virtual data structure can include one or more data blocks. The data blocks can be of the same size, but this is not necessarily so.

For convenience of explanation FIG. 5 illustrates three data blocks DB(1)-DB(3) 49(1)-49(3), each stored in K entries of the virtual FIFO data structure 44. Each group of K entries starts by a first entry (44(1), 44(K), 44(2K)) that stores metadata, while the rest of the group stores data that is associated with that metadata.

First entry 44(1), which is the first block's metadata entry, may contain management and protocol-specific information. For example, this metadata entry can contain three data fields: protocol-specific metadata 44(1,1), first/last data field 44(1,2) and data block size 44(1,3). The protocol specific metadata 44(1,1) can include various headers, such as HDLC headers. Such a header may include a number of flags field, a flag sharing enable field, a multiple frames in FIFO field, a time stamp, a CRC field, an abort flag, a number of bytes in a data block flag and the like.

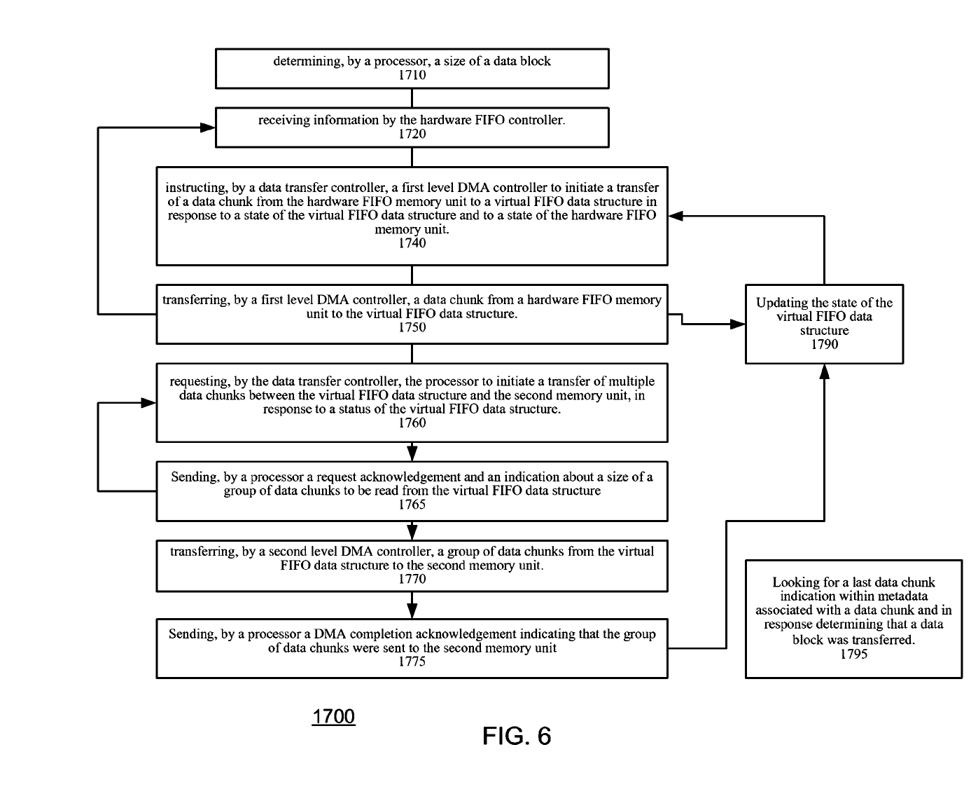

FIG. 6 illustrates a flow chart of method 1700 of receiving data, according to an embodiment of the invention.

Method 1700 starts by stage 1710 of determining, by a processor, a size of a data block. The determination can be responsive to various parameters such as communication protocol constraints, processor latency and the like. This size defines a maximal amount of data chunks that can be transferred between the hardware FIFO and the Virtual FIFO data structure using one GDC.

Stage 1710 is followed by stage 1720 of receiving information by the hardware FIFO memory unit.

Conveniently stage 1720 includes receiving data from a physical layer unit by utilizing high-speed communication protocols.

Stage 1720 is followed by stage 1740 of instructing, by a data transfer controller, a first level DMA controller to initiate a transfer of a data chunk from the hardware FIFO memory unit to a virtual FIFO data structure in response to a state of the virtual FIFO data structure and to a state of the hardware FIFO memory unit.

Conveniently, stage 1740 includes instructing, by multiple data transfer controllers, multiple first level DMA controllers to initiate multiple provisions of multiple data chunks from multiple hardware FIFO memory units in response to a state of at least one virtual FIFO data structure.

Stage 1740 is followed by stage 1750 of transferring, by a first level DMA controller, a data chunk from a hardware FIFO memory unit to a virtual FIFO data structure.

Conveniently, stage 1750 includes providing metadata and data chunks over substantially the same lines.

Stage 1750 is followed by stage 1760 and 1790. Stage 1790 includes updating the status of the virtual FIFO data structure. It is noted that stage 1790 can include defining a virtual state of the virtual FIFO data structure based upon request acknowledgments and defining a state of the virtual FIFO data structure based upon the DMA completion acknowledgements. In any case the status is also responsive to the progress of transfers by the first level DMA controller.

Stage 1760 includes requesting, by the data transfer controller, the processor to initiate a transfer multiple data chunks between the virtual FIFO data structure and the second memory unit, in response to a status of the virtual FIFO data structure. Stage 1760 can include requesting the processor to process multiple data chunks before transferring it to the second memory unit 43. The data transfer controller sends such a request if the virtual FIFO data structure includes one or more data chunks.

Stage 1760 is followed by stage 1765 of sending, by a processor a request acknowledgement and an indication about the size of a group of data chunks (GDC) to be read from the virtual FIFO data structure.

Stage 1765 is followed by stage 1770 of transferring, by a second level DMA controller, a GDC from the virtual FIFO data structure to the second memory unit. Stage 1765 may also be followed by stage 1760, which is, requesting the processor a transfer of a new GDC, as a result of stage's 1765 request acknowledgement.

Stage 1770 is followed by stage 1775 of sending by a processor a DMA completion acknowledgement indicating that the GDC was sent to the second memory unit. Stage 1775 can be followed by stage 1790.

Method 1700 can also include stage 1795 of looking for a last data chunk indication within metadata associated with a data chunk and in response determining that a data block was transferred.

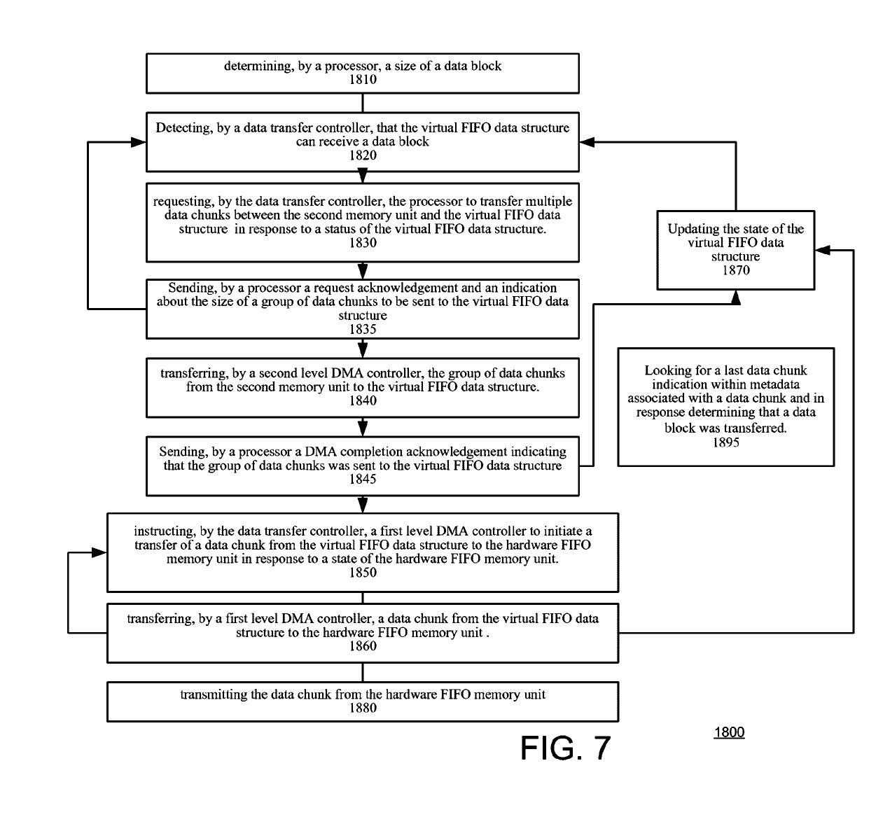

FIG. 7 illustrates a flow chart of method 1800 for transmitting data according to an embodiment of the invention.

Method 1800 starts by stage 1810 of determining, by a processor, a size of a data block. The determination can be responsive to various parameters such as communication protocol constraints, processor latency and the like. This size defines a maximal amount of data that is transferred in one GDC between the virtual FIFO data structure and the hardware FIFO.

Stage 1810 is followed by stage 1820 of detecting that the virtual FIFO data structure can receive a data block.

If the answer is positive stage 1820 is followed by stage 1830 of requesting, by the data transfer controller, the processor to transfer multiple data chunks between the second memory unit and the Virtual FIFO data structure. The request is responsive to the status of the virtual FIFO data structure. It is noted that the processor can further process the data block. The data transfer controller sends a request if the virtual FIFO data structure can receive at least a data block.

Stage 1830 is followed by stage 1835 of sending, by the processor a request acknowledgement and an indication about the size of a group of data chunks (GDC) to be sent to the virtual FIFO data structure.

Stage 1835 is followed by stage 1840 of transferring, by a second level DMA controller, a GDC from the second memory unit to the virtual FIFO data structure. Stage 1835 is also followed by stage 1820, for detecting if it is possible to issue an additional request data.

Stage 1840 is followed by stage 1845 of sending by a processor a DMA completion acknowledgement indicating that the GDC was sent to virtual FIFO data structure.

Stage 1845 is followed by stage 1850 of instructing, by a data transfer controller, a first level DMA controller to initiate a transfer of a data chunk from the virtual FIFO data structure to the hardware FIFO memory unit in response to a state of the hardware FIFO memory unit. Stage 1845 is also followed by stage 1870 of updating the state of the Virtual FIFO data structure.

Stage 1850 is followed by stage 1860 of transferring, by a first level DMA controller, a data chunk from the virtual FIFO data structure to the hardware FIFO memory unit. Stage 1860 is followed by stage 1850, 1870 and 1880.

The repetition of stages 1850 and 1860 can continue while the virtual FIFO data structure stores one or more data chunks that can be received by the hardware FIFO.

Stage 1880 includes transmitting the data chunk from the hardware FIFO memory unit. Stage 1880 can include utilizing high-speed communication protocols.

Conveniently, method 1800 includes stage 1895 of looking for a last data chunk indication within metadata associated with a data chunk and in response determining that a data block was transferred.

Conveniently, stage 1860 of transferring includes providing metadata and data chunks over substantially the same lines.

Conveniently, stage 1850 of instructing includes instructing, by multiple data transfer controllers, multiple first level DMA controllers to initiate multiple provisions of multiple data chunks to multiple hardware FIFO memory units in response to a state of at least one virtual FIFO data structure and in response to the state of the hardware FIFO memory units.

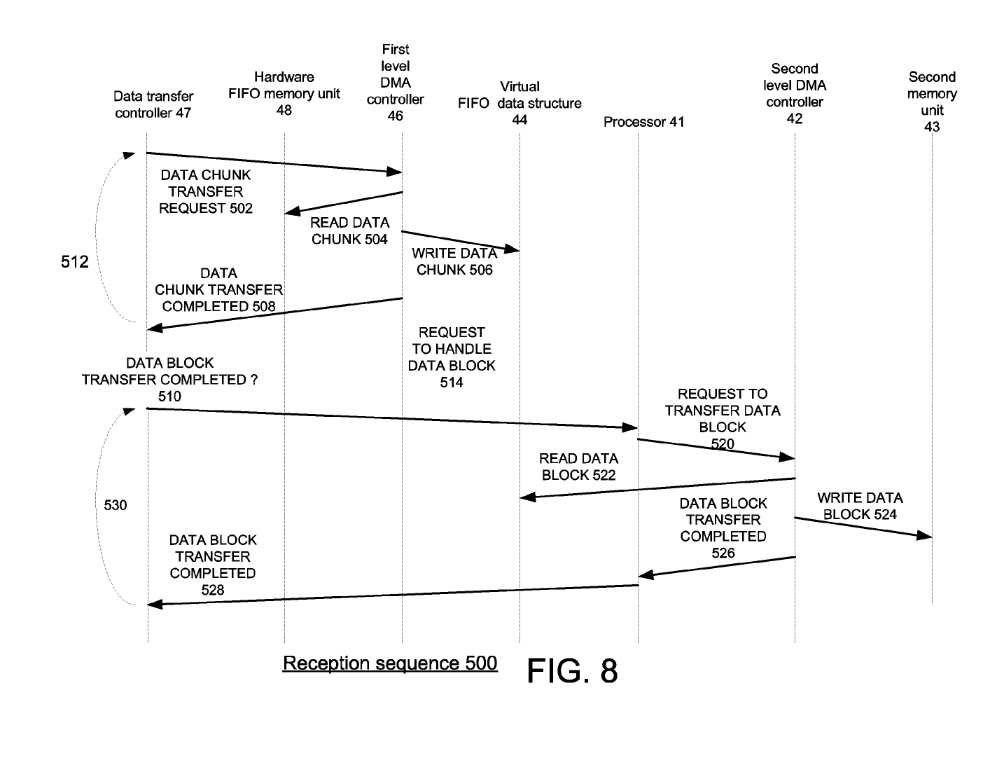

FIG. 8 illustrates various signals that are exchanged between various components of device 40, during reception sequence 500, according to an embodiment of the invention. It is assumed that data is transferred from the hardware FIFO memory unit 48 to the second memory unit 43.

Various operations and signals are illustrated by arrows that extend between components that are involved in various stages of the reception process.

A data reception process starts by a sending a request (DATA CHUNK TRANSFER REQUEST 502) to provide a data chunk from the hardware FIFO memory unit 48 to virtual FIFO data structure 44. The request is sent from data transfer controller 47 to first level DMA controller 46.

The first level DMA controller 46 accepts the request and reads a data chunk from the hardware FIFO memory unit 48. This stage is illustrates by arrow READ DATA CHUNK 504.

The first level DMA controller 46 then writes the data chunk to the virtual FIFO data structure 44. This stage is illustrates by arrow WRITE DATA CHUNK 506.

Once the data chunk transfer was completed the first level DMA controller 46 sends an indication (DATA CHUNK TRANSFER COMPLETED 508) to data transfer controller 47. If the virtual FIFO data structure is not completely full then the data transfer controller 47 initiates a provision of a new data chunk, as illustrated by dotted arrow 512.

The data transfer controller 47 also determines if a data block was transferred completely or not, as illustrated by query “DATA BLOCK TRANSFER COMPLETED?” 510.

If a data block was written to the virtual FIFO data structure then data transfer controller 47 requests the processor 41 to handle the data block. The handling can include the transferring of the data block to a second memory unit 43 but can also include processing the data block. The processing can be executed by the processor 41, but this is not necessarily so. Exemplary processing processes can include error correction stages and the like. The request is denoted REQUEST TO HANDLE DATA BLOCK 514.

The processor 41 accepts the request and when the processing (if any) of the data block ends it instructs the second level DMA controller 42 to transfer the data block to the second memory unit 43. This instruction is denoted REQUEST TO TRANSFER DATA BLOCK 520.

The second level DMA controller 42 accepts the request and reads a data block from the virtual FIFO data structure 44. This stage is illustrates by arrow READ DATA BLOCK 522.

The second level DMA controller 42 then writes the data block to the second memory unit 43. This stage is illustrates by arrow WRITE DATA BLOCK 524.

Once the data block transfer was completed the second level DMA controller 42 sends an indication (DATA BLOCK TRANSFER COMPLETED 526) to processor 41.

Processor 41 then sends an acknowledgement signal (DATA BLOCK TRANSFER COMPLETED 528) to the data transfer controller 47. The data transfer controller 47 then jumps (as indicated by dashed line 530) to query stage 510 to determine if another data block waits to being processed by processor 41.

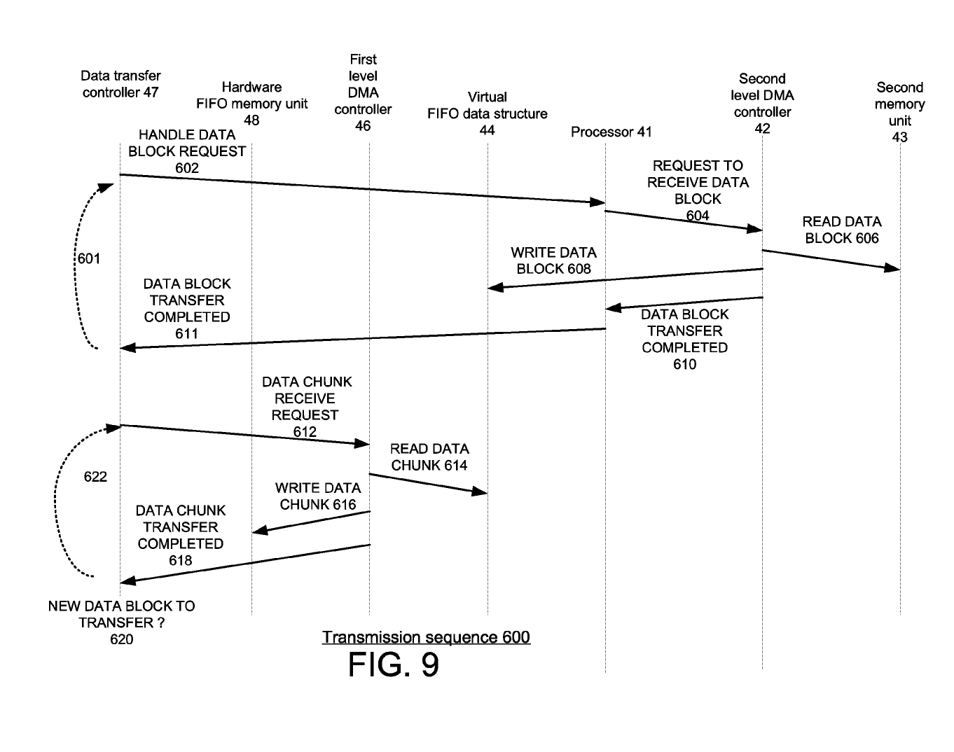

FIG. 9 illustrates various signals that are exchanged between various components of device 40, during transmission sequence 600, according to another embodiment of the invention.

It is assumed that data is transferred to the hardware FIFO memory unit 48 from the second memory unit 43.

It is assumed that the virtual FIFO data structure 44 is not full. The data transfer controller 47 can ask processor 41 to handle a data block that is stored in second memory unit 43 and to send it to the virtual FIFO data structure 44. This request is denoted HANDLE DATA BLOCK REQUEST 602.

The processor 41 accepts the request and after the processing ends instructs the second level DMA controller 42 to transmit the data block from the second memory unit 43 to the virtual FIFO data structure 44. This is indicated by arrow 604 “REQUEST TO TRANSMIT DATA BLOCK”.

The second level DMA controller 42 accepts the request and reads a data block from the second memory unit 43. This stage is illustrates by arrow READ DATA BLOCK 606.

The second level DMA controller 42 then writes the data block to the virtual FIFO data structure 44. This stage is illustrates by arrow WRITE DATA BLOCK 608.

Once the data block transfer was completed the second level DMA controller 42 sends an indication (DATA BLOCK TRANSFER COMPLETED 610) to processor 41.

Processor 41 then sends an acknowledgement signal (DATA BLOCK TRANSFER COMPLETED 611) to the data transfer controller 47. The data transfer controller 47 then jumps (as indicated by dashed line 601) to the beginning of the process and also proceeds with the provision of this data block, chunk by chunk, to the hardware FIFO memory unit 48.

Data transfer controller 47 checks whether the hardware FIFO memory unit 48 can receive a data chunk, and if the answer is positive, the data transfer controller sends to the first level DMA controller 46, a request to send a data chunk to the hardware FIFO memory unit 48. The request is referred to as DATA CHUNK TRANSMIT REQUEST 612.

The first level DMA controller 46 accepts the request and reads a data chunk from the virtual FIFO data structure 44. This stage is illustrates by arrow READ DATA CHUNK 614.

The first level DMA controller 46 then writes the data chunk to the hardware FIFO memory unit 48. This stage is illustrates by arrow WRITE DATA CHUNK 616.

Once the data chunk transfer was completed the first level DMA controller 46 sends an indication (DATA CHUNK TRANSFER COMPLETED 618) to data transfer controller 47.

The data transfer controller 47 then determines if there are more data chunks to transmit and is the answer is positive it sends a new data chink receive request, as illustrated by dotted arrow 622 that connects arrow 618 to arrow 612.

In addition, data transfer controller 47 also checks if there are new data blocks to transmit, as illustrated by “NEW DATA BLOCK TO TRANSFER?” 620. If the answer is positive then the data transfer controller may initiate a new request to handle a data block transfer request.

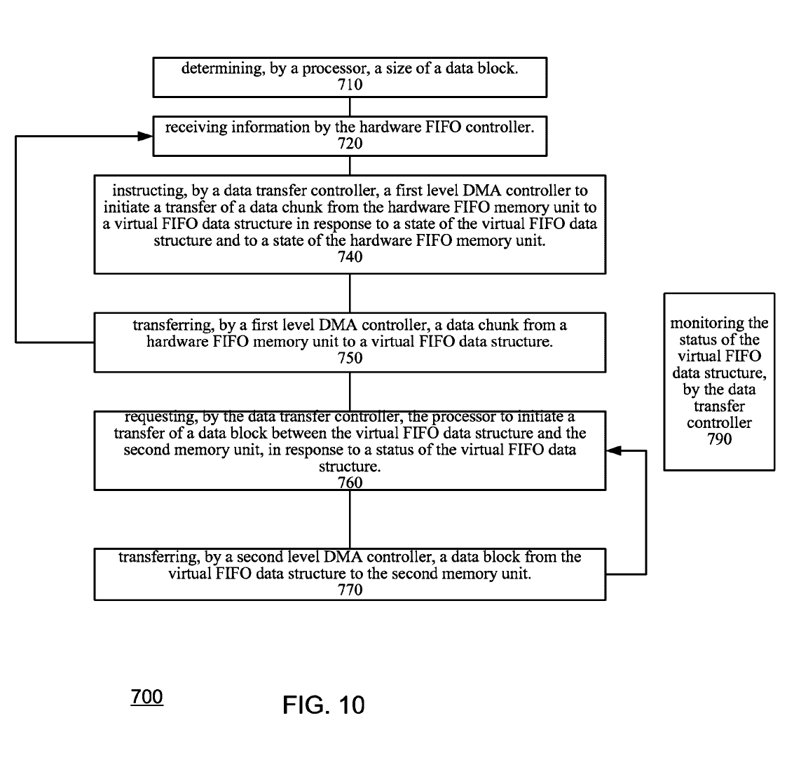

FIG. 10 illustrates a flow chart of method 700 of receiving data, according to an embodiment of the invention.

Method 700 starts by stage 710 of determining, by a processor, a size of a data block. The determination can be responsive to various parameters such as communication protocol constraints, processor latency and the like.

Stage 710 is followed by stage 720 of receiving information by the hardware FIFO controller.

Conveniently stage 720 includes receiving data from a physical layer unit by utilizing high-speed communication protocols.

Stage 720 is followed by stage 740 of instructing, by a data transfer controller, a first level DMA controller to initiate a transfer of a data chunk from the hardware FIFO memory unit to a virtual FIFO data structure in response to a state of the virtual FIFO data structure and to a state of the hardware FIFO memory unit.

Conveniently, stage 740 includes instructing, by multiple data transfer controllers, multiple first level DMA controllers to initiate multiple provisions of multiple data chunks from multiple hardware FIFO memory units in response to a state of at least one virtual FIFO data structure.

Stage 740 is followed by stage 750 of transferring, by a first level DMA controller, a data chunk from a hardware FIFO memory unit to a virtual FIFO data structure.

Conveniently, stage 750 includes providing metadata and data chunks over substantially the same lines.

Stage 750 is followed by stage 720 and 760.

Stage 760 includes requesting, by the data transfer controller, the processor to initiate a transfer of a data block between the virtual FIFO data structure and the second memory unit, in response to a status of the virtual FIFO data structure. Stage 760 can include requesting the processor to process the data block before transferring it to the second memory unit 43.

The request to transfer the data block is issued if the virtual FIFO data structure stores a data block that includes multiple data chunks.

Stage 760 is followed by stage 770 of transferring, by a second level DMA controller, a data block from the virtual FIFO data structure to the second memory unit. Stage 770 is followed by stage 760.

Conveniently, method 700 includes stage 790 of monitoring the status of the virtual FIFO data structure, by the data transfer controller. Stage 790 can be executed in parallel to various stages of method 700, such as stages 720-770.

Conveniently, the monitoring includes looking for a last data chunk indication within metadata associated with a data chunk and in response determining that a data block was transferred.

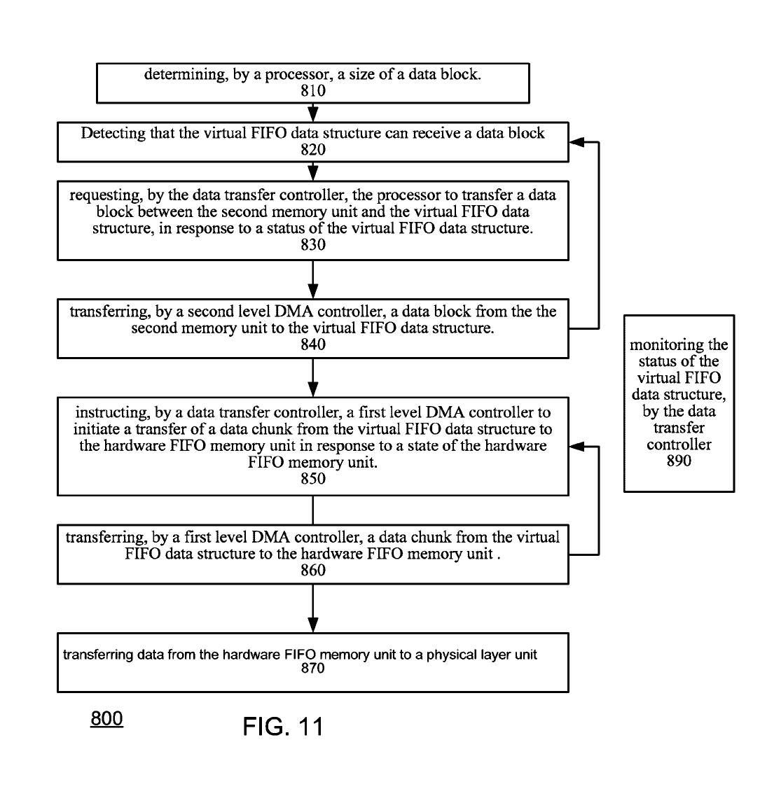

FIG. 11 illustrates a flow chart of method 800 for transmitting data according to an embodiment of the invention.

Method 800 starts by stage 810 of determining, by a processor, a size of a data block.

Stage 810 is followed by stage 820 of detecting that the virtual FIFO data structure can receive a data block. The data block includes multiple data chunks.

If the answer is positive stage 820 is followed by stage 830 of requesting, by the data transfer controller, the processor to transfer a data block between the second memory unit and the virtual FIFO data structure, in response to a status of the virtual FIFO data structure. It is noted that the processor can further process the data block.

Stage 830 is followed by stage 840 of transferring, by a second level DMA controller, a data block from the second memory unit to the virtual FIFO data structure.

Stage 840 is followed by stage 820 and 850. Stage 850 includes instructing, by a data transfer controller, a first level DMA controller to initiate a transfer of a data chunk from the virtual FIFO data structure to the hardware FIFO memory unit in response to a state of the hardware FIFO memory unit.

Stage 850 is followed by stage 860 of transferring, by a first level DMA controller, a data chunk from the virtual FIFO data structure to the hardware FIFO memory unit. Stage 860 is followed by stage 850 and also by stage 870 of transferring data from the hardware FIFO memory unit to a physical layer unit. Stage 870 can include utilizing high-speed communication protocols.

Conveniently, method 800 includes stage 890 of monitoring the status of the virtual FIFO data structure, by the data transfer controller. Stage 890 can be executed in parallel to various stages of method 800, such as stages 820-870.

Stage 890 can also include looking for a last data chunk indication within metadata associated with a data chunk and in response determining that a data block was transferred.

Conveniently, stage 850 of transferring includes providing metadata and data chunks over substantially the same lines.

Conveniently, stage 850 of instructing includes instructing, by multiple data transfer controllers, multiple first level DMA controllers to initiate multiple provisions of multiple data chunks to multiple hardware FIFO memory units in response to a state of at least one virtual FIFO data structure and in response to the state of the hardware FIFO memory units.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A device, comprising
a processor;
a hardware FIFO memory unit;
a first level DMA controller, a second level DMA controller, an first memory unit that stores at least one virtual FIFO data structure, wherein the first level DMA controller is coupled to the hardware FIFO memory unit and to the first memory unit and wherein the second level DMA controller is coupled to the first memory unit and to a second memory unit;
a data transfer controller, coupled to processor and to the first level DMA controller, wherein the data transfer controller initiates transfer of data chunks between the hardware FIFO memory unit and the virtual FIFO data structure and initiates transfers of multiple data chunks between the second memory unit and the virtual FIFO data structure;
wherein the processor is adapted to determine a size of a data block.

2. The device according to claim 1 wherein the multiple data chunks comprise a data block.

3. The device, according to claim 1 wherein the data transfer controller is adapted to request from the processor to manage a data transfer of multiple data chunks between the second memory unit and the virtual FIFO data structure, to receive an indication from the processor that the request was accepted as well as a indication of a size of a group of data chunks to be handled, and, in response to a state of at least the virtual FIFO data structure, request from the processor to manage a data transfer of other data chunks between the second memory unit and the virtual FIFO data structure.

4. The device according to claim 3 wherein the processor is further adapted to send to the data transfer controller a group of data chunks transfer indication indicative that the group of data chunks was transferred between the second memory unit and the virtual FIFO data structure, wherein the processor is further adapted to send to the data transfer controller another group of data chunks transfer indication indicative that another group of data chunks was transferred between the second memory unit and the virtual FIFO data structure.

5. The device according to claim 1 wherein the processor is adapted to receive requests to manage data transfers of multiple data chunks from multiple data transfer controllers.

6. The device according to claim 5 wherein the processor is adapted to send multiple reception indications in an order that corresponds to an order of reception of the requests to manage data transfers of multiple data chunks.

7. The device according to claim 1 wherein processor is adapted to indicate a size of the group of data chunks to be handled by the processor.

8. The device according to claim 1 wherein the data transfer controller is adapted to look for a last data chunk indication within metadata associated with a data chunk and in response to determine that a data block was transferred.

9. The device according to claim 1 wherein the first level DMA controller transfers data and metadata associated to the data over substantially the same lines.

10. A method comprising:
transferring, by a first level DMA controller, a data chunk from a hardware FIFO memory unit to a virtual FIFO data structure;
transferring, by a second level DMA controller, a data block from the virtual FIFO data structure to a second memory unit;
wherein a data block comprises multiple data chunks;
determining, by a processor, a size of a data block;
instructing, by a data transfer controller, a first level DMA controller to initiate a transfer of the data chunk from the hardware FIFO memory unit to the virtual FIFO data structure in response to a state of the virtual FIFO data structure and to a state of the hardware FIFO memory unit;
requesting, by the data transfer controller, the processor to initiate a transfer of multiple data chunks from the virtual FIFO data structure to the second memory unit, in response to a status of the virtual FIFO data structure.

11. The method according to claim 10 wherein the multiple data chunks comprise a data block.

12. The method according to claim 10 further comprising monitoring the status of the virtual FIFO data structure, by the data transfer controller.

13. The method according to claim 10 wherein the monitoring comprises looking for a last data chunk indication within metadata associated with a data chunk and in response determining that a data block was transferred.

14. The method according to claim 10 wherein the transferring, by a first level DMA controller, data chunks comprises providing data and data chunks over substantially the same lines.

15. The method according to claim 10, wherein the method further comprises:
sending, by the processor a request acknowledgment and an indication about a size of a group of data chunks to be transferred from the virtual FIFO data structure;
updating the state of the virtual FIFO data structure and transferring, by the second level DMA controller, a group of data chunks from the virtual FIFO data structure to the second memory unit.

16. The method according to claim 10, further comprising looking for a last data chunk indication within metadata associated with a data chunk and in response determining that a data block was transferred.

17. The method according to claim 10, wherein the method comprises instructing, by multiple data transfer controllers, multiple first level DMA controllers to initiate multiple provisions of multiple data chunks from multiple hardware FIFO memory units in response to a state of at least one virtual FIFO data structure.

18. A method comprising:
transferring, by the second level DMA controller, multiple data chunks from the second memory unit to the virtual FIFO data structure;
transferring, by a first level DMA controller, a data chunk from the virtual FIFO data structure to the hardware FIFO memory unit;
requesting, by the data transfer controller, the processor to initiate a transfer of multiple data chunks from the second memory unit to the Virtual FIFO data structure, in response to a status of the virtual FIFO data structure and instructing, by a data transfer controller, a first level DMA controller to initiate a transfer of a data chunk from the virtual FIFO data structure to the hardware FIFO memory unit in response to a state of the hardware FIFO memory unit.

19. The method according to claim 18 further comprising:
sending, by the processor, a request acknowledgment and an indication about a size of a group of data chunks to be transferred to the virtual FIFO data structure;
updating the state of the virtual FIFO data structure; and
sending, by the processor a DMA completion acknowledgment indicating that the group of data chunks was written to the virtual FIFO data structure.

20. The method according to claim 18 further comprising looking for a last data chunk indication within metadata associated with a data chunk and in response determining that a data block was transferred.

21. The method according to claim 18 wherein the multiple data chunks comprise a data block.
